(19) United States
(12) Patent Application Publication
(10) Pub. No.: US 2025/0373188 A1
(43) Pub. Date: Dec. 4, 2025

(54) MOTOR CONTROL APPARATUS AND MOTOR CONTROL SYSTEM

(71) Applicant: Hitachi Astemo, Ltd., Ibaraki (JP)

(72) Inventors: Haruhiko FUJITA, Ibaraki (JP); Takuya USUI, Ibaraki (JP); Daisuke GOTO, Ibaraki (JP)

(21) Appl. No.: 18/876,867

(22) PCT Filed: Jun. 30, 2023
(86) PCT No.: PCT/JP2023/024361

§ 371 Date: Dec. 19, 2024

(30) Foreign Application Priority Data
Jul. 22, 2022 (JP) 2022-117009

(51) Int. Cl. H02P 29/028; B60T 13/74; H02P 25/22

(52) U.S. Cl. CPC H02P 29/028; B60T 13/74; H02P 25/22

(57) ABSTRACT

A motor control apparatus includes a first motor driving portion, a second motor driving portion, a first control portion, a second control portion, and a third control portion. The first control portion acquires a detection value of a first rotational sensor, which detects a rotational position of a brake motor, and monitors a phase current of the second motor driving portion. The second control portion acquires a detection value of a second rotational sensor, which detects the rotational position of the brake motor, and monitors a phase current of the first motor driving portion. The third control portion acquires a detection value of a third rotational sensor, which detects the rotational position of the brake motor, and monitors the phase current of the first motor driving portion and the phase current of the second motor driving portion.

### TECHNICAL FIELD

The present disclosure relates to a motor control apparatus and a motor control system.

### BACKGROUND ART

PTL 1 discloses that a driving control system of a motor is duplicated and redundantly arranged with the aim of maintaining the functionality of an electric power steering according to requirements of autonomous driving, functional safety, and the like of a vehicle.

### CITATION LIST

### Patent Literature

PTL 1: Japanese Patent Application Laid-Open No. 2016-171664

### SUMMARY OF INVENTION

### Technical Problem

In the redundantly arranged driving control of the motor like PTL 1, each system should be equipped with a built-in function capable of self-diagnosing the abnormality detection function to allow each system to reliably detect an abnormality in itself, and the cost may increase accordingly.

One of objects of the present invention is to provide a motor control apparatus and a motor control system capable of achieving a cost reduction while establishing redundancy.

### Solution To Problem

According to the present invention, preferably, a motor control apparatus includes a first motor driving portion configured to drive a motor, a second motor driving portion configured to drive the motor, a first control portion connected to the first motor driving portion and configured to acquire a detection value of a first rotational position detection portion, which detects a rotational position of the motor, and monitor a phase current of the second motor driving portion, a second control portion connected to the second motor driving portion and configured to acquire a detection value of a second rotational position detection portion, which detects the rotational position of the motor, and monitor a phase current of the first motor driving portion, and a third control portion configured to acquire a detection value of a third rotational position detection portion, which detects the rotational position of the motor, and monitor the phase current of the first motor driving portion and the phase current of the second motor driving portion.

Further, according to the present invention, preferably, a motor control system includes a motor, and a motor controller configured to control the motor. Preferably, the motor controller includes a first motor driving portion configured to drive the motor, a second motor driving portion configured to drive the motor, a first control portion connected to the first motor driving portion and configured to acquire a detection value of a first rotational position detection portion, which detects a rotational position of the motor, and monitor a phase current of the second motor driving portion, a second control portion connected to the second motor driving portion and configured to acquire a detection value of a second rotational position detection portion, which detects the rotational position of the motor, and monitor a phase current of the first motor driving portion, and a third control portion configured to acquire a detection value of a third rotational position detection portion, which detects the rotational position of the motor, and monitor the phase current of the first motor driving portion and the phase current of the second motor driving portion. Preferably, the motor control system further includes a vehicle controller connected to the first control portion, the second control portion, and the third control portion.

According to one aspect of the present invention, the cost reduction can be achieved while the redundancy is established.

### BRIEF DESCRIPTION OF DRAWINGS

FIG. 1 is a block diagram illustrating a motor control apparatus and a motor control system according to an embodiment.

FIG. 2 is a block diagram illustrating a first control portion (M_ECU_1), a third control portion (S_ECU), a second control portion (M_ECU_2), a first logical circuit (LC), a first motor driving portion, and the like.

FIG. 3 is a block diagram illustrating the second control portion (M_ECU_2), the third control portion (S_ECU), the first control portion (M_ECU_1), a second logical circuit (LC), a second motor driving portion, and the like.

FIG. 4 illustrates characteristic lines indicating one example of time-series changes (waveforms) of phase currents (a U phase, a V phase, and a W phase) by the first motor driving portion or the second motor driving portion.

FIG. 5 is a flowchart illustrating processing (current monitoring processing) performed by the first control portion (M_ECU_1), the second control portion (M_ECU_2), and the third control portion (S_ECU).

FIG. 6 illustrates tables (truth tables) indicating the relationships between the outputs (L or H) of the first control portion (ECU 1), the second control portion (ECU 2), and the third control portion (Sens ECU), and the states (L: OFF, H: ON) of a first fail-safe relay (ECU 1_FS relay) and a second fail-safe relay (ECU 2_FS relay).

### DESCRIPTION OF EMBODIMENTS

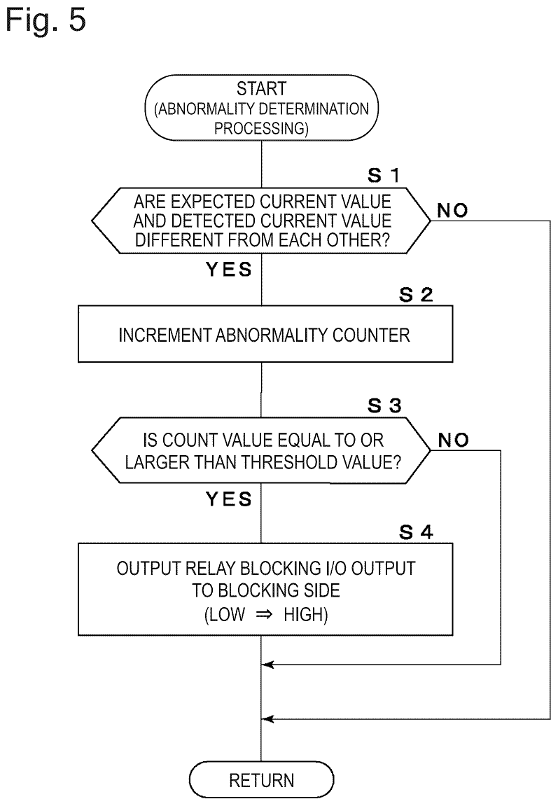

In the following description, a motor control apparatus and a motor control system according to an embodiment will be described with reference to the accompanying drawings, citing an example in which they are mounted on a four-wheeled automobile. Each step in a flowchart illustrated in FIG. 5 will be represented by a symbol “S” (for example, each step will be indicated like step 1=“S1”).

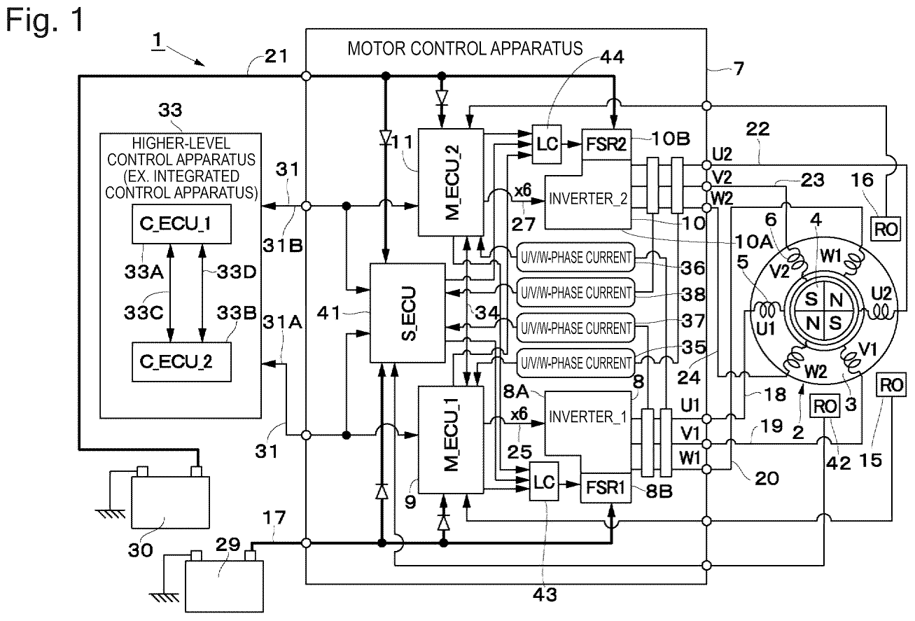

In FIG. 1, a motor control system 1 mounted on a vehicle (an automobile) includes a brake motor 2 as a motor, a motor control apparatus 7 as a motor controller, and a higher-level control apparatus 33 as a controller of the vehicle (a vehicle controller). In the embodiment, the higher-level control apparatus 33 corresponds to an integrated controller that determines control of a motion of the vehicle. Hereinafter, the higher-level control apparatus 33 will be referred to as an integrated control apparatus 33.

The brake motor 2 controls (drives) an electric brake mechanism (not illustrated) that provides a braking force to the vehicle. The electric brake mechanism corresponds to, for example, an electric disk brake including an electric caliper that presses brake pads against a disk rotor using the brake motor 2, which is an electric motor. The brake motor 2 includes a stator 3 serving as a stationary element, and a rotor 4 serving as a permanent magnet rotor rotatably provided at a central portion of the stator 3. The rotor 4 of the brake motor 2 is connected to, for example, a rotational shaft of a not-illustrated rotation-linear motion conversion mechanism. The rotation of the brake motor 2 (the rotor 4) is converted into a liner motion by the rotation-linear motion conversion mechanism, and causes the brake pads of the electric brake mechanism to be moved toward and separated from the disk rotor.

The brake motor 2 includes two winding sets 5 and 6 to secure redundancy. More specifically, the brake motor 2 is configured as a three-phase synchronous motor including the first winding set 5 constituted by three-phase windings U1, V1, and W1 connected via a star connection and the second winding set 6 constituted by three-phase windings U2, V2, and W2 also connected via a star connection. In other words, the brake motor 2 is configured as a six-phase motor having dual three-phase windings (a six-phase motor that generates a torque using two three-phase coil systems for the single rotor 4). The first winding set 5 and the second winding set 6 are provided on the stator 3 in a state of being isolated from each other.

The electric brake mechanism (the electric brake) is not limited to the electric disk brake, and may be embodied using, for example, an electric drum brake including an electric cylinder that provides a braking force by pressing shoes against a drum using an electric motor. Alternatively, the electric brake mechanism (the electric brake) may be embodied using a hydraulic disk brake including an electric motor (a hydraulic disk brake equipped with an electric parking brake function), or a cable puller-type electric parking brake that actuates the application of a parking brake by pulling a cable using an electric motor. In other words, various types of electric brakes (electric brake mechanisms) can be used as the electric brake (the electric brake mechanism), as long as the electric brake is configured to be able to press (thrust) a frictional member (pads or shoes) against a rotational member (a rotor or a drum) based on driving of an electric motor (an electric actuator), and provide and release a braking force (maintain and release a pressing force).

The motor control apparatus 7 as the motor controller controls the brake motor 2 as the motor. More specifically, the motor control apparatus 7 controls driving of each of the windings U1, V1, and W1 of the first winding set 5 and each of the windings U2, V2, and W2 of the second winding set 6 of the brake motor 2. To fulfill this function, the motor control apparatus 7 includes a first driving control system (a first motor driving portion 8 and a first control portion 9) that controls the driving of the first winding set 5 (U1, V1, and W1) and a second driving control system (a second motor driving portion 10 and a second control portion 11) that controls the driving of the second winding set 6 (U2, V2, and W2).

In other words, the motor control apparatus 7 includes the first motor driving portion 8, the first control portion 9, the second motor driving portion 10, and the second control portion 11. Further, the motor control apparatus 7 includes a third control portion 41, which will be described below. The first driving control system of the motor control apparatus 7 will also be referred to as, for example, a “primary channel”, a “first control portion 9 side”, or an “ECU 1 side”. Further, the second driving control system of the motor control apparatus 7 will also be referred to as, for example, a “secondary channel”, a “second control portion 11 side”, or an “ECU 2 side”.

The first motor driving portion 8 drives the brake motor 2. The first motor driving portion 8 includes, for example, a first inverter circuit 8A as a first bridge circuit portion, and a first fail-safe relay 8B as a first relay portion. The first motor driving portion 8 is connected to a first electric power source 29 of the vehicle, such as an electric storage device (a battery), via a first direct-current electric power line 17. In this case, the first electric power source 29 (the first direct-current electric power line 17) is connected to the first inverter circuit 8A via the first fail-safe relay 8B of the first motor driving portion 8. The first fail-safe relay 8B will be described below. Further, the first motor driving portion 8 (the first inverter circuit 8A) is connected to the windings U1, V1, and W1 of the first winding set 5 of the brake motor 2 via a U1-phase power line 18, a V1-phase power line 19, and a W1-phase power line 20, respectively. Further, the first motor driving portion 8 (the first inverter circuit 8A) is connected to the first control portion 9 via a first signal line 25.

The first inverter circuit 8A includes a plurality of switching elements constituted by, for example, a transistor, a field-effect transistor (FET), and an insulated gate bipolar transistor (IGBT). For example, the first inverter circuit 8A corresponds to an inverter constituted by six FETs (a three-phase bridge inverter). Opening/closing of each of the switching elements of the first inverter circuit 8A is controlled based on an instruction signal (for example, a pulse signal) from the first control portion 9. When driving the brake motor 2, the first inverter circuit 8A generates three-phase (the U phase, the V phase, and the W phase) alternating-current electric power from direct-current electric power based on the instruction signal from the first control portion 9, and supplies this alternating-current electric power to the first winding set 5 (each of the windings U1, V1, and W1) of the brake motor 2.

The first control portion 9 is connected to the first motor driving portion 8. The first control portion 9 is also called an ECU (Electronic Control Unit), and includes a microcomputer serving as an arithmetic circuit (a CPU). The first control portion 9 corresponds to a first motor ECU (M_ECU_1). The first control portion 9 includes, for example, an electric power circuit (Power Management IC), a microcomputer (Micro Controller), a driver circuit (Pre Driver), and a regulator (Reg). The first control portion 9 is connected to the first electric power source 29 of the vehicle via the first direct-current electric power line 17, and is also connected to the first motor driving portion 8 via the first signal line 25. The first control portion 9 drives the brake motor 2 (rotates it in a forward/reverse direction) by controlling (performing switching control, more specifically, PWM control on) the first motor driving portion 8 (the first inverter circuit 8A).

The first control portion 9 is connected to a first rotational sensor 15 for performing feedback control on the rotation of the rotor 4 of the brake motor 2. The first rotational sensor 15 as a first rotational position detection portion detects the rotational position (for example, the rotational angle) of the rotor 4 of the brake motor 2. Further, a vehicle data bus 31 serving as a communication line is connected to the first control portion 9. The vehicle data bus 31 constitutes, for example, a CAN (Controller Area Network) as a communication network mounted on the vehicle body. A large number of electronic apparatuses mounted on the vehicle, such as various kinds of ECUs including the motor control apparatus 7, the integrated control apparatus 33, which will be described below, a suspension control apparatus (not illustrated), and a steering control apparatus (not illustrated), carry out in-vehicle multiplex communication with one another via the vehicle data bus 31. Various types of communication standards, such as CAN (Classic CAN) or CAN FD (CAN with Flexible Data Rate), can be employed as the communication standard.

The second motor driving portion 10 also drives the brake motor 2, similarly to the first motor driving portion 8. The second motor driving portion 10 includes, for example, a second inverter circuit 10A as a second bridge circuit portion, and a second fail-safe relay 10B as a second relay portion. The second motor driving portion 10 is connected to a second electric power source 30 of the vehicle, such as an electric storage device (a battery), via a second direct-current electric power line 21. In this case, the second electric power source 30 (the second direct-current electric power line 21) is connected to the second inverter circuit 10A via the second fail-safe relay 10B of the second motor driving portion 10. The second fail-safe relay 10B will be also described below. Further, the second motor driving portion 10 (the second inverter circuit 10A) is connected to the windings U2, V2, and W2 of the second winding set 6 of the brake motor 2 via a U2-phase power line 22, a V2-phase power line 23, and a W2-phase power line 24, respectively. The second electric power source 30 is an electric power source separate from the first electric power source 29 connected to the first motor driving portion 8 and the first control portion 9 (an electric power source in the other system). The redundancy is secured by providing dual systems as the supply route of the electric power source in this manner. Further, the second motor driving portion 10 (the second inverter circuit 10A) is connected to the second control portion 11 via a second signal line 27.

The second inverter circuit 10A also includes a plurality of switching elements constituted by, for example, a transistor, a field-effect transistor (FET), and an insulated gate bipolar transistor (IGBT). For example, the second inverter circuit 10A corresponds to an inverter constituted by six FETs (a three-phase bridge inverter). Opening/closing of each of the switching elements of the second inverter circuit 10A is controlled based on an instruction signal (for example, a pulse signal) from the second control portion 11. When driving the brake motor 2, the second inverter circuit 10A generates three-phase (the U phase, the V phase, and the W phase) alternating-current electric power from direct-current electric power based on the instruction signal from the second control portion 11, and supplies this alternating-current electric power to the second winding set 6 (each of the windings U2, V2, and W2) of the brake motor 2.

The second control portion 11 is connected to the second motor driving portion 10. The second control portion 11 is also called an ECU (Electronic Control Unit), and includes a microcomputer serving as an arithmetic circuit (a CPU). The second control portion 11 corresponds to a second motor ECU (M_ECU_2). The second control portion 11 includes, for example, an electric power circuit (Power Management IC), a microcomputer (Micro Controller), a driver circuit (Pre Driver), and a regulator (Reg). The second control portion 11 is connected to the second electric power source 30 of the vehicle via the second direct-current electric power line 21, and is also connected to the second motor driving portion 10 via the second signal line 27. The second control portion 11 drives the brake motor 2 (rotates it in the forward/reverse direction) by controlling (performing switching control, more specifically, PWM control on) the second motor driving portion 10 (the second inverter circuit 10A).

The second control portion 11 is connected to a second rotational sensor 16 for performing feedback control on the rotation of the rotor 4 of the brake motor 2. The second rotational sensor 16 as a second rotational position detection portion detects the rotational position (for example, the rotational angle) of the rotor 4 of the brake motor 2. The second rotational sensor 16 is also a rotational sensor separate from the first rotational sensor 15 connected to the first motor control portion 9. Due to that, the redundancy is secured. Further, the vehicle data bus 31 is connected to the second control portion 11, similarly to the first control portion 9. Further, the second control portion 11 and the first control portion 9 are connected to each other via a communication line 34 (a communication line between CPUs.)

The regulator (Reg) of the first control portion 9 is connected to the first rotational sensor 15, a first logical circuit 43, which will be described below, and a first phase-current monitor circuit 35, which will be described below, although the illustration thereof is omitted. Due to that, electric power is supplied to the first rotational sensor 15, the first logical circuit 43, and the first phase-current monitor circuit 35 via the regulator (Reg) of the first control portion 9. Further, the regulator (Reg) of the second control portion 11 is connected to the second rotational sensor 16, a second logical circuit 44, which will be described below, and a second phase-current monitor circuit 36, which will be described below. Due to that, electric power is supplied to the second rotational sensor 16, the second logical circuit 44, and the second phase-current monitor circuit 36 via the regulator (Reg) of the second control portion 11.

The integrated control apparatus 33 is connected to the first control portion 9 and the second control portion 11. More specifically, the integrated control apparatus 33 is connected to the first control portion 9 and the second control portion 11 via, for example, the vehicle data bus 31. In this case, the integrated control apparatus 33 is connected to the first control portion 9 and the second control portion 11 via separate systems, respectively. In other words, connections are established “between the integrated control apparatus 33 and the first control portion 9”, and “between the integrated control apparatus 33 and the second control portion 11” via separate communication lines 31A and 31B, respectively. As will be described below, the integrated control apparatus 33 is also connected to the third control portion 41. In this case, the integrated control apparatus 33 is connected to the third control portion 41 via the communication line 31A of a first system, which connects the integrated control apparatus 33 and the first control portion 9, and is connected to the third control portion 41 via the communication line 31B of a second system, which connects the integrated control apparatus 33 and the second control portion 11. Due to that, the first control portion 9, the second control portion 11, the third control portion 41, and the integrated control apparatus 33 establish a ring network.

The integrated control apparatus 33 is an integrated control apparatus (an integrated ECU) that, for example, determines vehicle motion control for moving the vehicle according to a target trajectory acquired from an autonomous driving control apparatus (an autonomous driving ECU). The integrated control apparatus 33 outputs a necessary control instruction (for example, a control instruction regarding autonomous driving) to each actuator control apparatus (an actuator ECU), such as a motor driving apparatus (a motor driving ECU), a brake control apparatus (a brake ECU), the steering control apparatus (a steering ECU), and the suspension control apparatus (a suspension ECU).

In the present example, the motor control apparatus 7 can serve as both the motor driving apparatus (the motor driving ECU) that drives the brake motor 2 and the brake control apparatus (the brake ECU) in charge of integrated control regarding the brake at the same time. In other words, the motor control apparatus 7 (the brake motor control ECU) can be integrally configured as a control apparatus having both the motor driving function and the brake control function. However, the motor control apparatus 7 is not limited thereto, and, for example, the motor driving apparatus (the motor driving ECU) and the brake control apparatus (the brake ECU) may be configured individually separately (as separate apparatuses).

On the other hand, the integrated control apparatus 33 is also called a central control apparatus (a central ECU), and corresponds to the higher-level control apparatus superior to the motor control apparatus 7. The integrated control apparatus 33 also includes a microcomputer serving as an arithmetic circuit (a CPU). In this case, the integrated control apparatus 33 has a dual-core (dual-circuit) configuration so as to be able to, for example, mutually monitor whether a difference lies between processing results along with performing the same processing in parallel. In other words, the integrated control apparatus 33 includes two control portions 33A and 33B (a first central ECU (C_ECU_1) and a second central ECU (C_ECU_2)). The two control portions 33A and 33B are connected to each other via communication lines 33C and 33D (communication lines between CPUs.) The integrated control apparatus 33, for example, outputs an instruction indicating a target motor torque (or a braking force, a piston thrust force, or a motor control current value) to the motor control apparatus 7 when applying the braking force to the vehicle.

Then, the driving control unit of the motor discussed in the above-described patent literature, PTL 1 employs a six-phase motor having six sets of windings to secure redundancy as a motor for generating a steering assist torque. In the case of such a configuration, it is conceivable to dispose ASILD chipsets (power management ICs that monitor microcomputers, microcomputers, and pre-drivers) prepared as completely independent two systems, and control three phases and the other three phases of the six-phase motor by separate ASILD chipsets, respectively.

In this case, the driving control unit of the motor can be configured to cause each system to carry out detection of its own abnormality in itself, and, if an abnormality is detected, cause the abnormal system to set this system itself to fail-open and the other system to generate a remaining torque corresponding to remaining 50%. However, two expensive chipsets including a BIST (a built-in self-test circuit) capable of self-diagnosing the abnormality detection function should be prepared to allow each system to reliably detect its own abnormality in itself in the configuration including full redundant-type two systems. As a result, the cost may increase.

In light thereof, in the embodiment, an inexpensive chipset capable of fulfilling the main function (the motor control function) although being insufficient for a full safety function is employed for each of the ECU 1 (the first control portion 9) of the primary channel (the first motor driving portion 8 and the first control portion 9), which serves as one of systems for securing the redundant function, and the ECU 2 (the second control portion 11) of the secondary channel (the second motor driving portion 10 and the second control portion 11), which serves as remaining one of the systems. Then, the ECU 1 (the first control portion 9) and the ECU 2 (the second control portion 11) made of the inexpensive chipsets check that the main function of the other of them (the function of appropriately supplying a current to the brake motor 2) works appropriately.

More specifically, the ECU 1 (the first control portion 9) and the ECU 2 (the second control portion 11) monitor the motor phase current (the motor current of each of the U, V, and W phases), which is a final output from the function of the ECU (an electronic component) of the other of them. Then, in the case of an abnormality, i.e., if a current is not appropriately supplied to the motor (the brake motor 2), the ECU 1 and the ECU 2 shut down the function of the other of them, i.e., switch off the relay of the other of them (the first fail-safe relay 8B or the second fail-safe relay 10B).

However, there remains such a risk that a defective microcomputer (microcontroller) may be unable to correctly detect a failure in the function of the other. Therefore, if the defective microcomputer inadvertently shuts down the relay of the other, this may cause the remaining output capability of the motor to fall to 0% in combination with the failure in the current control function of this defective microcomputer itself. To prevent that, in the embodiment, the third control portion and the third detection portion (the third rotational position detection portion) are additionally provided. In other words, in the embodiment, not only the ECU 1 (the first control portion 9) and the ECU 2 (the second control portion 11) but also the sensor ECU (S_ECU) operable as the ECU 3 (the third control portion 41) are provided. The ECU 3 (Sens ECU) includes a functional block that monitors the “rotational position of the motor (the angle of the rotor)”, the “phase current by the primary channel (the ECU 1)”, and the “phase current by the secondary channel (the ECU 2)”.

The ECU 3 determines an abnormality in the primary channel (the ECU 1) and the secondary channel (the ECU 2) as a third party. Then, if a determination “the primary channel is abnormal” by the ECU 3 matches a determination “the primary channel is abnormal” by the secondary channel (the ECU 2), the relay of the primary channel is blocked. Further, if a determination “the secondary channel is abnormal” by the ECU 3 matches a determination “the secondary channel is abnormal” by the primary channel (the ECU 1), the relay of the secondary channel is blocked. In other words, the embodiment adds a majority-vote determination function of blocking the relay based on an AND condition (an AND operation or a logical conjunction) between the result of the determination by the ECU 3 and the result of the determination by the primary channel (the ECU 1) or the secondary channel (the ECU 2).

As a result, even when an inexpensive microcomputer is employed for the ECU 1 (the first control portion 9) and the ECU 2 (the second control portion 11), the function of outputting a current to the motor (the brake motor 2) can be prevented from entirely failing when this inexpensive microcomputer is abnormal. This means that the embodiment allows an inexpensive device to be employed without using an expensive device. Further, the inexpensive chipset insufficient in terms of the safety function can be formed with components small in size, thereby allowing the substrate therefor to have a smaller size. In addition, the reduction in the size of the substrate brings about a further advantage in, for example, packaging when it is employed for a mechanical and electrical integrated actuator (a mechatronic combination actuator) subjected to a strict space constraint. Moreover, the size reduction and the simplification of the substrate can facilitate the assembling. Further, a failure rate is lowered due to a reduction in the component scale (including the scale of the logical circuit in the IC). The details of them will be described below.

In the embodiment, the motor control apparatus 7 includes the first motor driving portion 8, the second motor driving portion 10, the first control portion 9, the second control portion 11, and the third control portion 41. The first motor driving portion 8 drives the brake motor 2 serving as the motor. The second motor driving portion 10 also drives the brake motor 2 serving as the motor. The first control portion 9 is connected to the first motor driving portion 8. The first control portion 9 acquires the detection value of the first rotational sensor 15 serving as the first rotational position detection portion that detects the rotational position of the brake motor 2, and monitors the phase current of the second motor driving portion 10. To fulfill this function, the first phase-current monitor circuit 35 is connected to the U2-phase power line 22, the V2-phase power line 23, and the W2-phase power line 24 of the second motor driving portion 10. The first phase-current monitor circuit 35 is connected to the first control portion 9, and the first control portion 9 monitors the phase current of the second motor driving portion 10 by the first phase-current monitor circuit 35. The first control portion 9 determines that the second control portion 11 or the second motor driving portion 10 is abnormal if the monitor value of the first phase-current monitor circuit 35 falls out of a normal range.

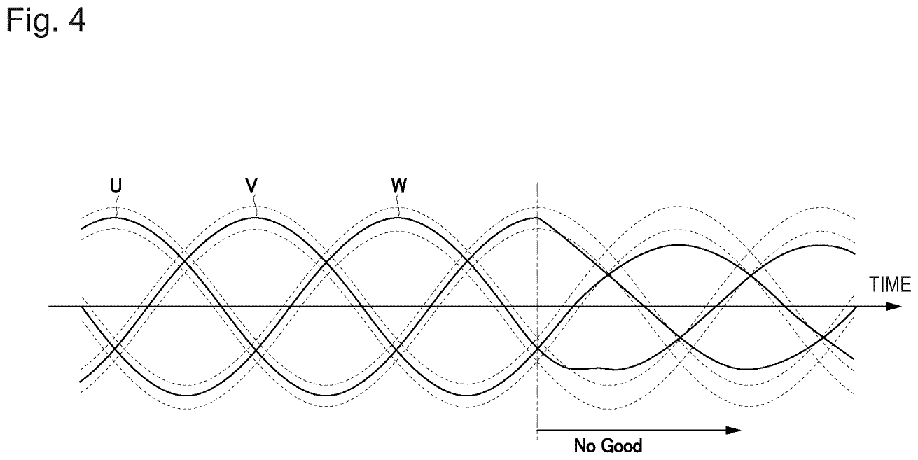

More specifically, the first control portion 9 determines that the second control portion 11 and the second motor driving portion 10 are normal if the waveform of the phase current in the second motor driving portion 10 is within a range of an expected current waveform, and determines that the second control portion 11 or the second motor driving portion 10 is abnormal if the waveform of the phase current in the second motor driving portion 10 is outside the range of the expected current waveform. FIG. 4 illustrates one example of time-series changes (waveforms) of the phase currents (the U phase, the V phase, and the W phase) in the second motor driving portion 10. In FIG. 4, the range of the expected current waveform is indicated by long dashed double-short dashed lines. The range of the expected current waveform can be set to, for example, a range of a current waveform satisfied when the second motor driving portion 10 and thus the second control portion 11 are in a proper state. In this case, the first control portion 9 can determine a correct current waveform (the phase and the crest value of the current) of each of the three U, V, and W-phase currents to apply to the brake motor 2 based on, for example, the instruction (the target motor torque, the braking force, the piston thrust force, or the motor control current value) from the integrated control apparatus 33, which is the higher-level ECU, and a magnet polarity arrangement acquired from the detection value of the first rotational sensor 15. Then, when the waveform of the phase current in the second motor driving portion 10 falls out of the range of the expected current waveform (the correct current waveform) as stated as “No good” in FIG. 4, the first control portion 9 determines that the second control portion 11 or the second motor driving portion 10 is abnormal.

In the embodiment, an inexpensive chipset that does not self-diagnose abnormality detection is employed for the first control portion 9. Under this condition, the first control portion 9 determines whether the behavior of the motor phase current of the second motor driving portion 10 connected to the second control portion 11 defined as the other side is normal or abnormal. Then, if the waveform of the phase current in the second motor driving portion 10 is outside the range of the expected current waveform, the first control portion 9 outputs a signal indicating that the second control portion 11 or the second motor driving portion 10 is abnormal, i.e., a signal for stopping the driving of the second motor driving portion 10 to the second fail-safe relay 10B via the second logical circuit 44.

The signal for stopping the driving of the second motor driving portion 10 corresponds to an abnormality instruction signal (ECU2_Disable signal) for blocking the second fail-safe relay 10B. In other words, the first control portion 9 outputs an abnormality instruction signal (a third abnormality instruction signal) for blocking the second fail-safe relay 10B as the second relay portion based on the current phase determined based on the detection value of the first rotational sensor 15 and the phase current value of the second motor driving portion 10. In this case, 1 (High) can be set as the abnormality instruction signal. In other words, the first control portion 9 outputs 0 (Low) set as a normality instruction signal if the waveform of the phase current in the second motor driving portion 10 is within the range of the expected current waveform, and outputs 1 (High) set as the abnormality instruction signal if the waveform of the phase current in the second motor driving portion 10 is outside the range of the expected current waveform.

On the other hand, the second control portion 11 is connected to the second motor driving portion 10. The second control portion 11 acquires the detection value of the second rotational sensor 16 serving as the second rotational position detection portion that detects the rotational position of the brake motor 2, and monitors the phase current of the first motor driving portion 8. To fulfill this function, the second phase-current monitor circuit 36 is connected to the U1-phase power line 18, the V1-phase power line 19, and the W1-phase power line 20 of the first motor driving portion 8. The second phase-current monitor circuit 36 is connected to the second control portion 11, and the second control portion 11 monitors the phase current of the first motor driving portion 8 by the second phase-current monitor circuit 36. The second control portion 11 determines that the first control portion 9 or the first motor driving portion 8 is abnormal if the monitor value of the second phase-current monitor circuit 36 falls out of a normal range.

More specifically, the second control portion 11 determines that the first control portion 9 and the first motor driving portion 8 are normal if the waveform of the phase current in the first motor driving portion 8 is within a range of an expected current waveform, and determines that the first control portion 9 or the first motor driving portion 8 is abnormal if the waveform of the phase current in the first motor driving portion 8 is outside the range of the expected current waveform. FIG. 4 also corresponds to one example of the time-series changes (the waveforms) of the phase currents (the U phase, the V phase, and the W phase) in the first motor driving portion 8. The long dashed double-short dashed lines in FIG. 4, i.e., the range of the expected current waveform can be set to, for example, the range of the current waveform satisfied when the first motor driving portion 8 and thus the first control portion 9 are in a proper state. In this case, the second control portion 11 can determine a correct current waveform (the phase and the crest value of the current) of each of the three U, V, and W-phase currents to apply to the brake motor 2 based on, for example, the instruction (the target motor torque, the braking force, the piston thrust force, or the motor control current value) from the integrated control apparatus 33, which is the higher-level ECU, and the magnet polarity arrangement acquired from the detection value of the second rotational sensor 16. Then, when the waveform of the phase current in the first motor driving portion 8 falls out of the range of the expected current waveform (the correct current waveform) as stated by “No good” in FIG. 4, the second control portion 11 determines that the first control portion 9 or the first motor driving portion 8 is abnormal.

In the embodiment, an inexpensive chipset that does not self-diagnose abnormality detection is employed for the second control portion 11. Under this condition, the second control portion 11 determines whether the behavior of the motor phase current of the first motor driving portion 8 connected to the first control portion 9 defined as the other side is normal or abnormal. Then, if the waveform of the phase current in the first motor driving portion 8 is outside the range of the expected current waveform, the second control portion 11 outputs a signal indicating that the first control portion 9 or the first motor driving portion 8 is abnormal, i.e., a signal for stopping the driving of the first motor driving portion 8 to the first fail-safe relay 8B via the first logical circuit 43.

The signal for stopping the driving of the first motor driving portion 8 corresponds to an abnormality instruction signal (ECU1_Disable signal) for blocking the first fail-safe relay 8B. In other words, the second control portion 11 outputs an abnormality instruction signal (a first abnormality instruction signal) for blocking the first fail-safe relay 8B as the first relay portion based on the current phase determined based on the detection value of the second rotational sensor 16 and the phase current value of the first motor driving portion 8. In this case, 1 (High) can be set as the abnormality instruction signal. In other words, the second control portion 11 outputs 0 (Low) set as the normality instruction signal if the waveform of the phase current in the first motor driving portion 8 is within the range of the expected current waveform, and outputs 1 (High) set as the abnormality instruction signal if the waveform of the phase current in the first motor driving portion 8 is outside the range of the expected current waveform.

Further, the third control portion 41 acquires the detection value of the third rotational sensor 42 serving as the third rotational position detection portion that detects the rotational position of the brake motor 2, and monitors the phase current of the first motor driving portion 8 and the phase current of the second motor driving portion 10. To fulfill this function, the third control portion 41 is connected to the third rotational sensor 42. The third rotational sensor 42 detects the rotational position (for example, the rotational angle) of the rotor 4 of the brake motor 2. The third rotational sensor 42 is a rotational sensor separate from the first rotational sensor 15 connected to the first control portion 9 and the second rotational sensor 16 connected to the second control portion 11. Due to that, the redundancy is secured.

Further, a third phase-current monitor circuit 37 is connected to the U1-phase power line 18, the V1-phase power line 19, and the W1-phase power line 20 of the first motor driving portion 8. The third phase-current monitor circuit 37 is connected to the third control portion 41, and the third control portion 41 monitors the phase current of the first motor driving portion 8 by the third phase-current monitor circuit 37. Further, a fourth phase-current monitor circuit 38 is connected to the U2-phase power line 22, the V2-phase power line 23, and the W2-phase power line 24 of the second motor driving portion 10. The fourth phase-current monitor circuit 38 is connected to the third control portion 41, and the third control portion 41 monitors the phase current of the second motor driving portion 10 by the fourth phase-current monitor circuit 38.

The third control unit 41 includes, for example, a microcomputer (Micro Controller) and a regulator (Reg). The third control portion 41 is connected to the first electric power source 29 of the vehicle via the first direct-current electric power line 17. Further, the third control portion 41 is connected to the second electric power source 30 of the vehicle via the second direct-current electric power line 21. The regulator (Reg) of the third control portion 41 is connected to the third rotational sensor 42, the third phase-current monitor circuit 37, and the fourth phase-current monitor circuit 38, although the illustration thereof is omitted. Due to that, electric power is supplied to the third rotational sensor 42, the third phase-current monitor circuit 37, and the fourth phase-current monitor circuit 38 via the regulator (Reg) of the third control portion 41. The regulator (Reg) that supplies electric power may be a component separate from the third control portion 41. In this case, this separate regulator (Reg) is connected to the first electric power source 29 and the second electric power source 30, and electric power is supplied to the third control portion 41, the third rotational sensor 42, the third phase-current monitor circuit 37, and the fourth phase-current monitor circuit 38 via this separate regulator (Reg).

The third control portion 41 determines that the first control portion 9 or the first motor driving portion 8 is abnormal if the monitor value of the third phase-current monitor circuit 37 falls out of a normal range. The third control portion 41 determines that the second control portion 11 or the second motor driving portion 10 is abnormal if the monitor value of the fourth phase-current monitor circuit 38 falls out of a normal range. The third control portion 41 determines the abnormality in a similar manner to the determination about the waveform of the phase current by the first control portion 9 and the determination about the waveform of the phase current by the second control portion 11. In this case, the third control portion 41 can determine a correct current waveform (the phase and the crest value of the current) of each of the three U, V, and W-phase currents to apply to the brake motor 2 based on, for example, the instruction (the target motor torque, the braking force, the piston thrust force, or the motor control current value) from the integrated control apparatus 33, which is the higher-level ECU, and the magnet polarity arrangement acquired from the detection value of the third rotational sensor 42.

In the embodiment, a chipset unequipped with the motor driving function, i.e., a low-functionality chipset can be employed for the third control portion 41. In other words, an inexpensive microcomputer for monitoring can be employed for the third control portion 41. Due to that, the cost reduction can be achieved. Under this condition, the third control portion 41 determines whether the behavior of the motor phase current of the first motor driving portion 8 connected to the first control portion 9 is normal or abnormal. Along therewith, the third control portion 41 determines whether the behavior of the motor phase current of the second motor driving portion 10 connected to the second control portion 11 is normal or abnormal. Then, if the waveform of the phase current in the first motor driving portion 8 is outside the range of the expected current waveform, the third control portion 41 outputs a signal for stopping the driving of the first motor driving portion 8 to the first fail-safe relay 8B via the first logical circuit 43. The signal for stopping the driving of the first motor driving portion 8 corresponds to the abnormality instruction signal (ECU1_Disable signal) for blocking the first fail-safe relay 8B. Further, if the waveform of the phase current in the second motor driving portion 10 is outside the range of the expected current waveform, the third control portion 41 outputs a signal for stopping the driving of the second motor driving portion 10 to the second fail-safe relay 10B via the second logical circuit 44. The signal for stopping the driving of the second motor driving portion 10 corresponds to the abnormality instruction signal (ECU2_Disable signal) for blocking the second fail-safe relay 10B.

In other words, the third control portion 41 outputs an abnormality instruction signal (a second abnormality instruction signal) for blocking the first fail-safe relay 8B based on the current phase determined based on the detection value of the third rotational sensor 42 and the phase current value of the first motor driving portion 8. Further, the third control portion 41 outputs an abnormality instruction signal (a fourth abnormality instruction signal) for blocking the second fail-safe relay 10B based on the current phase determined based on the detection value of the third rotational sensor 42 and the phase current value of the second motor driving portion 10. In this case, 1 (High) can be set as the abnormality instruction signal. In other words, the third control portion 41 outputs 0 (Low) set as the normality instruction signal if the waveform of the phase current in the first motor driving portion 8 is within the range of the expected current waveform, and outputs 1 (High) set as the abnormality instruction signal if the waveform of the phase current in the first motor driving portion 8 is outside the range of the expected current waveform. Further, the third control portion 41 outputs 0 (Low) set as the normality instruction signal if the waveform of the phase current in the second motor driving portion 10 is within the range of the expected current waveform, and outputs 1 (High) set as the abnormality instruction signal if the waveform of the phase current in the second motor driving portion 10 is outside the range of the expected current waveform.

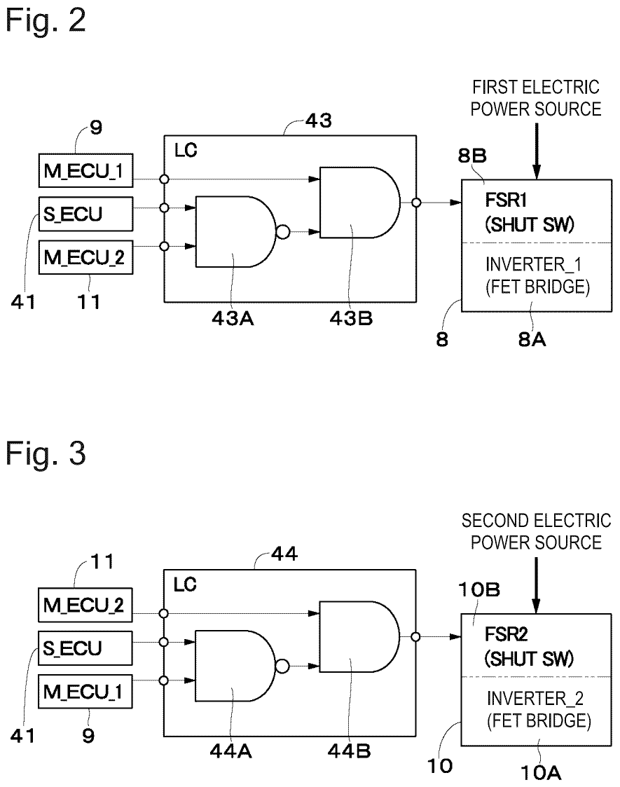

Next, the first fail-safe relay 8B, the second fail-safe relay 10B, the first logical circuit 43, and the second logical circuit 44 will be described with additional reference to FIGS. 2 and 3 together with FIG. 1.

As illustrated in FIGS. 1 and 2, the first motor driving portion 8 includes the first inverter circuit 8A as the first bridge circuit portion, and the first fail-safe relay 8B as the first relay portion. The first fail-safe relay 8B switches the connection and the disconnection between the first inverter circuit 8A and the first electric power source 29, which is the electric power source. The first control portion 9, the second control portion 11, and the third control portion 41 are connected to the first fail-safe relay 8B via the first logical circuit 43. The first fail-safe relay 8B is switched off (OFF) and disconnects the first inverter circuit 8A and the first electric power source 29 when the output from the first logical circuit 43 is 0 (Low). On the other hand, the first fail-safe relay 8B is switched on (ON) and connects the first inverter circuit 8A and the first electric power source 29 when the output from the first logical circuit 43 is 1 (High). The first logical circuit 43 corresponds to a relay switching portion (a first relay switching portion) that switches the connection (ON) and the disconnection (OFF) of the first fail-safe relay 8B based on the signal (Low or High) from the first control portion 9, the second control portion 11, and the third control portion 41.

On the other hand, as illustrated in FIGS. 1 and 3, the second motor driving portion 10 includes the second inverter circuit 10A as the second bridge circuit portion, and the second fail-safe relay 10B as the second relay portion. The second fail-safe relay 10B switches the connection and the disconnection between the second inverter circuit 10A and the second electric power source 30, which is the electric power source. The first control portion 9, the second control portion 11, and the third control portion 41 are connected to the second fail-safe relay 10B via the second logical circuit 44. The second fail-safe relay 10B is switched off (OFF) and disconnects the second inverter circuit 10A and the second electric power source 30 when the output from the second logical circuit 44 is 0 (Low). On the other hand, the second fail-safe relay 10B is switched on (ON) and connects the second inverter circuit 10A and the second electric power source 30 when the output from the second logical circuit 44 is 1 (High). The second logical circuit 44 corresponds to a relay switching portion (a second relay switching portion) that switches the connection (ON) and the disconnection (OFF) of the second fail-safe relay 10B based on the signal (Low or High) from the first control portion 9, the second control portion 11, and the third control portion 41.

As illustrated in FIG. 2, the first logical circuit 43 includes a NAND circuit 43A and an AND circuit 43B. The output side of the third control portion 41 and the output side of the second control portion 11 are connected to the input side of the NAND circuit 43A. The output side of the NAND circuit 43A is connected to the input side of the AND circuit 43B. The NAND circuit 43A outputs 0 (Low) set as the abnormality instruction signal to the AND circuit 43B if 1 (High) set as the abnormality instruction signal is input from both the third control portion 41 and the second control portion 11. On the other hand, the NAND circuit 43A outputs 1 (High) set as the normality instruction signal to the AND circuit 43B if 0 (Low) set as the normality instruction signal is input from at least one of the third control portion 41 or the second control portion 11. In other words, the NAND circuit 43A outputs 1 (High) set as the normality instruction signal unless 1 (High) set as the abnormality instruction signal is input from both the third control portion 41 and the second control portion 11.

The output side of the first control portion 9 and the output side of the NAND circuit 43A are connected to the input side of the AND circuit 43B. This means that the third control portion 41 and the second control portion 11 are connected to the AND circuit 43B via the NAND circuit 43A. On the other hand, the output side of the AND circuit 43B is connected to the first fail-safe relay 8B of the first motor driving portion 8. Now, the first control portion 9 outputs a signal for enabling the driving of the first motor driving portion 8 (the first inverter circuit 8A) (an Enable signal) to the first logical circuit 43 (the AND circuit 43B). This signal corresponds to a driving permission signal for permitting the driving of the first motor driving portion 8, i.e., a signal for permitting the connection of the first fail-safe relay 8B. In this case, 1 (High) can be set as the driving permission signal. In other words, the first control portion 9 outputs 1 (High) set as the driving permission signal if permitting the driving of the first motor driving portion 8 (the first inverter circuit 8A) and outputs 0 (Low) set as a driving prohibition signal if not permitting the driving of the first motor driving portion 8 (the first inverter circuit 8.A).

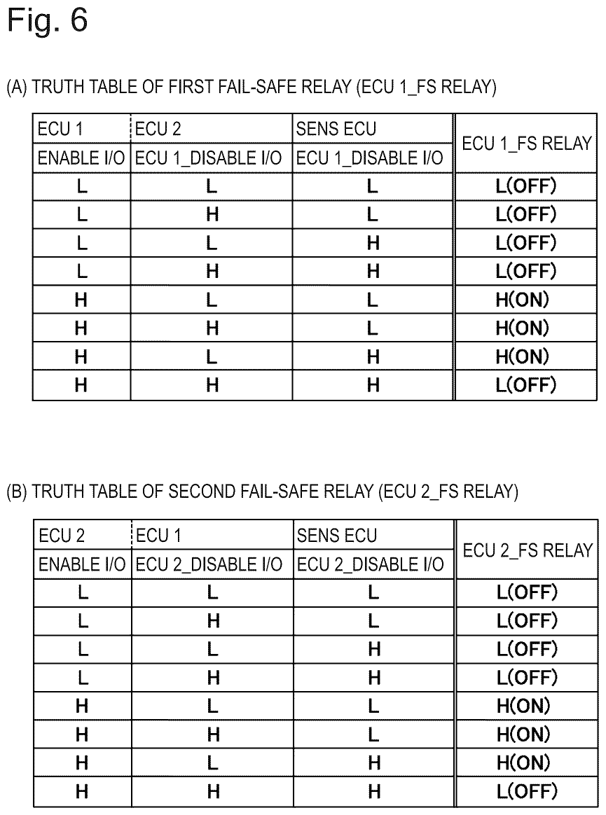

The AND circuit 43B outputs 1 (High) corresponding to the signal for connecting the first fail-safe relay 8B to the first fail-safe relay 8B if 1 (High) set as the driving permission signal is input from the first control portion 9 and 1 (High) set as the normality instruction signal is input from the NAND circuit 43A. Due to that, the first fail-safe relay 8B is switched on (ON) and connects the first inverter circuit 8A and the first electric power source 29. On the other hand, the AND circuit 43B outputs 0 (Low) corresponding to the signal for blocking the first fail-safe relay 8B to the first fail-safe relay 8B if ((Low) set as the driving prohibition signal is input from the first control portion 9 or 0 (Low) set as the abnormality instruction signal is input from the NAND circuit 43A. Due to that, the first fail-safe relay 8B is switched off (OFF) and disconnects the first inverter circuit 8A and the first electric power source 29. FIG. 6 (A) is a truth table of the first fail-safe relay 8B. As illustrated in FIG. 6 (A), the first fail-safe relay 8B is blocked if 1 (High) set as the abnormality instruction signal (the first abnormality instruction signal and the second abnormality instruction signal) is output from both the third control portion 41 and the second control portion 11, even when 1 (High) set as the driving permission signal is output from the first control portion 9. Due to that, the driving of the first motor driving portion 8 (the first inverter circuit 8A) is stopped. In other words, in the embodiment, the first fail-safe relay 8B is blocked if both the first abnormality instruction signal and the second abnormality instruction signal are output.

On the other hand, as illustrated in FIG. 3, the second logical circuit 44 also includes a NAND circuit 44A and an AND circuit 44B. The second logical circuit 44 is different from the first logical circuit 43 in terms of the fact that the output side of the third control portion 41 and the output side of the first control portion 9 are connected to the input side of the NAND circuit 44A, the output side of the second control portion 11 is connected to the input side of the AND circuit 44B, and the output side of the AND circuit 44B is connected to the second fail-safe relay 10B of the second motor driving portion 10. Other than that, the second logical circuit 44 is configured similarly to the first logical circuit 43, and therefore the detailed description of the second logical circuit 44 will be omitted herein. FIG. 6 (B) is a truth table of the second fail-safe relay 10B. As illustrated in FIG. 6 (B), the second fail-safe relay 10B is blocked if 1 (High) set as the abnormality instruction signal (the third abnormality instruction signal and the fourth abnormality instruction signal) is output from both the third control portion 41 and the first control portion 9, even when 1 (High) set as the driving permission signal is output from the second control portion 11. Due to that, the driving of the second motor driving portion 10 (the second inverter circuit 10A) is stopped. In other words, in the embodiment, the second fail-safe relay 10B is blocked if both the third abnormality instruction signal and the fourth abnormality instruction signal are output.

Further, as illustrated in FIG. 1, in the embodiment, the first control portion 9, the second control portion 11, and the third control portion 41 are connected to the integrated control apparatus 33 serving as the controller of the vehicle. Then, when the first fail-safe relay 8B is blocked, the second control portion 11 or the third control portion 41 notifies the integrated control apparatus 33 of the abnormality in the first control portion 9 or the first motor driving portion 8. Further, when the second fail-safe relay 10B is blocked, the first control portion 9 or the third control portion 41 notifies the integrated control apparatus 33 of the abnormality in the second control portion 11 or the second motor driving portion 10. Further, both the first control portion 9 and the second control portion 11 are unequipped with the self-diagnosis function. In other words, the ASIL rating of the first control portion 9 and the ASIL rating of the second control portion comply with ASIL-B.

On the other hand, the integrated control apparatus 33 (the control portions 33A and 33B) is equipped with the self-diagnosis function. In other words, the ASIL rating of the integrated control apparatus 33 (the control portions 33A and 33B) complies with, for example, ASIL-D. Further, the third control portion 41 is connected to the integrated control apparatus 33 via the communication line 31A of the first system, which connects the first control portion 9 and the integrated control apparatus 33. Further, the third control portion 41 is connected to the integrated control apparatus 33 via the communication line 31B of the second system, which connects the second control portion 11 and the integrated control apparatus 33. Due to that, the first control portion 9, the second control portion 11, the third control portion 41, and the integrated control apparatus 33 establish a ring network.

As described above, in the embodiment, an inexpensive chipset unequipped with the function of self-diagnosing abnormality detection is employed for the first control portion 9 and the second control portion 11. Then, the first control portion 9 and the second control portion 11 determine whether the behavior of the phase current of the motor driving portion on the other side (the second motor driving portion 10 for the first control portion 9 and the first motor driving portion 8 for the second control portion 11) is normal or abnormal. The normality of the behavior of the motor phase current can be determined based on whether the correct current waveform (the phase and the crest value of the current) can be acquired.

In other words, the first control portion 9 and the second control portion 11 can recognize the magnitude of the control current based on the target motor torque (or the braking force. the piston thrust force, or the motor control current value) instructed from the integrated control apparatus 33, which is the higher-level ECU, via the communication. Further, the first control portion 9 and the second control portion 11 can correctly recognize the magnet polarity arrangement of the rotor 4 of the brake motor 2 by the first rotational sensor 15 or the second rotational sensor 16, which is the motor rotational angle sensor (the angle sensor) connected to the first control portion 9 or the second control portion 11 itself, and correctly recognize the three U, V, and W-phase currents to apply to the brake motor 2. Due to them. the first control portion 9 and the second control portion 11 can determine the correct current waveform (the phase and the crest value of the current).

Then, the first control portion 9 and the second control portion 11 detect the phase current of the motor driving portion on the other side (the second motor driving portion 10 for the first control portion 9 and the first motor driving portion 8 for the second control portion 11) by the phase-current motor circuit 35 or 36, which is the current detection circuit (the current monitor circuit). Due to that, the first control portion 9 can be aware of the occurrence of some abnormality on the other side when the current waveform of the second motor driving portion 10 acquired by the first phase-current monitor circuit 35 does not match the correct current waveform (the phase and the crest value of the current). The second control portion 11 can be aware of the occurrence of some abnormality on the other side when the current waveform of the first motor driving portion 8 acquired by the second phase-current monitor circuit 36 does not match the correct current waveform (the phase and the crest value of the current).

The first control portion 9 and the second control portion 11 block the relay on the other side (the first fail-safe relay 8B or the second fail-safe relay 10B) when being aware that an abnormality has occurred on the other side. For example, the first control portion 9 blocks the second fail-safe relay 10B of the second motor driving portion 10 to stop the driving of the brake motor 2 by the second motor driving portion 10. The second control portion 11 blocks the first fail-safe relay 8B of the first motor driving portion 8 to stop the driving of the brake motor 2 by the first motor driving portion 8. This can block a bias of electric power supplied to the brake motor 2 when an abnormality has occurred on the other side.

Now, when an abnormality has occurred in the microcomputer on the other side and the control current on the other side deviates from the correct current waveform, the relay on the other side can be blocked by detecting that. In this case, 50% can be secured as the remaining brake force. However, suppose that the first control portion 9 or the second control portion 11 has an abnormality in its own microcomputer and has a control current deviating from the correct current waveform in itself, and also erroneously determines the control current on the other side. This case raises a possibility that, because this defective control portion blocks the normal relay on the other side and the other side also blocks the relay of the defective control portion, both the relays end up being blocked. This results in 0% remaining as the brake force, and therefore is undesirable.

In light thereof, in the embodiment, the motor controller includes the simple microcomputer capable of making a determination as a third party, the motor rotor angle sensor, and the current detection circuit. In other words, the motor control apparatus 7, which is the motor controller in the embodiment, includes the third control portion 41, which is the sensor ECU (Sens ECU), the third rotational sensor 42, and the third phase-current monitor circuit 37 and the fourth phase-current monitor circuit 38. The third control portion 41 predicts the current (the phase current) of the first motor driving portion 8 and the current (the phase current) of the second motor driving portion 10 based on the “instruction torque from the integrated control apparatus 33 (the instruction from the upstream side)” and the “rotational position from the third rotational sensor 42 (the angle of the motor rotor)”.

The third control portion 41 compares the “predicted current (phase current)”, and the “current (phase current) detected by the third phase-current monitor circuit 37”, and the “current (phase current) detected by the fourth phase-current monitor circuit 38”. If the “current (phase current) detected by the third phase-current monitor circuit 37” deviates from the “predicted current (phase current)”, the third control portion 41 determines that an abnormality has occurred in the first control portion 9 or the first motor driving portion 8. When determining that an abnormality has occurred in the first control portion 9 or the first motor driving portion 8, the third control portion 41 outputs the abnormality instruction signal (1: High) corresponding to the presence of an abnormality to the first logical circuit 43 on the first motor driving portion 8 side (the first fail-safe relay 8B side). Further, if the “current (phase current) detected by the fourth phase-current monitor circuit 38” deviates from the “predicted current (phase current)”, the third control portion 41 determines that an abnormality has occurred in the second control portion 11 or the second motor driving portion 10. When determining that an abnormality has occurred in the second control portion 11 or the second motor driving portion 10, the third control portion 41 outputs the abnormality instruction signal (1: High) corresponding to the presence of an abnormality to the second logical circuit 44 on the second motor driving portion 10 side (the second fail-safe relay 10B side).

On the other hand, the first control portion 9 predicts the current (the phase current) of the second motor driving portion 10 based on the “instruction torque from the integrated control apparatus 33 (the instruction from the upstream side)” and the “rotational position from the first rotational sensor 15 (the angle of the motor rotor)”. The first control portion 9 compares the “predicted current (phase current)”, and the “current (phase current) detected by the first phase-current monitor circuit 35”. If the “current (phase current) detected by the first phase-current monitor circuit 35” deviates from the “predicted current (phase current)”. the first control portion 9 determines that an abnormality has occurred in the second control portion 11 or the second motor driving portion 10. When determining that an abnormality has occurred in the second control portion 11 or the second motor driving portion 10, the first control portion 9 outputs the abnormality instruction signal (1: High) corresponding to the presence of an abnormality to the second logical circuit 44 on the second motor driving portion 10 side (the second fail-safe relay 10B side).

Further, the second control portion 11 predicts the current (the phase current) of the first motor driving portion 8 based on the “instruction torque from the integrated control apparatus 33 (the instruction from the upstream side)” and the “rotational position from the second rotational sensor 16 (the angle of the motor rotor)”. The second control portion 11 compares the “predicted current (phase current)”, and the “current (phase current) detected by the second phase-current monitor circuit 36”. If the “current (phase current) detected by the second phase-current monitor circuit 36” deviates from the “predicted current (phase current)”, the second control portion 11 determines that an abnormality has occurred in the first control portion 9 or the first motor driving portion 8. When determining that an abnormality has occurred in the first control portion 9 or the first motor driving portion 8, the second control portion 11 outputs the abnormality instruction signal (1: High) corresponding to the presence of an abnormality to the first logical circuit 43 on the first motor driving portion 8 side (the first fail-safe relay 8B side).

Then, if both the first control portion 9 and the third control portion 41 determine an abnormality, i.e., if the abnormality instruction signal (1: High) is input from both the first control portion 9 and the third control portion 41 to the second logical circuit 44 on the second fail-safe relay 10B side, the second logical circuit 44 outputs the signal for the disconnection (0: Low) to the second fail-safe relay 10B. Accordingly, the second fail-safe relay 10B is blocked, and the driving of the brake motor 2 by the second motor driving portion 10 is stopped. At this time, the driving of the brake motor 2 by the first control portion 9 (for example, an output of 50%) is continued. Further, if both the second control portion 11 and the third control portion 41 determine an abnormality, i.e., if the abnormality instruction signal (1: High) is input from both the second control portion 11 and the third control portion 41 to the first logical circuit 43 on the first fail-safe relay 8B side, the first logical circuit 43 outputs the signal for the disconnection (0): Low) to the first fail-safe relay 8B. Accordingly, the first fail-safe relay 8B is blocked, and the driving of the brake motor 2 by the first motor driving portion 8 is stopped. At this time, the driving of the brake motor 2 by the second control portion 11 (for example, an output of 50%) is continued.

In this manner, the first control portion 9, the second control portion 11, and the third control portion 41 each output the signal for blocking the relay, i.e., the abnormality instruction signal (1: High) to the logical circuit 43 or 44 when determining an abnormality. Then, the fail-safe relay 8B or 10B is blocked when both the signal from the “first control portion 9 or the second control portion 11” and the signal from the “third control portion 41” are input to the logical circuit 43 or 44. In other words, only when an AND condition is established between the blocking signal of the first control portion 9 or the second control portion 11 (the abnormality instruction signal) and the blocking signal of the third control portion 41 (the abnormality instruction signal), the fail-safe relay 8B, 10B is blocked. This results in a stop of the electric power supply from the motor driving portion 8, 10 on the determined abnormal side to the brake motor 2.

The motor control apparatus and the motor control system of the four-wheeled automobile according to the embodiment are configured in the above-described manner, and the operation thereof will be described next.

For example, the integrated control apparatus 33 outputs the torque control request instruction serving as the instruction for driving the brake motor 2 to the first control portion 9 and the second control portion 11. The first control portion 9 and the second control portion 11 drive the brake motor 2 with currents via the first motor driving portion 8 and the second motor driving portion 10 using a control map based on the torque control request instruction and the rotational positions of the first rotational sensor 15 and the second rotational sensor 16. Further, the torque control request instruction from the integrated control apparatus 33 is also input to the third control portion 41. The third control portion 41 predicts the phase current of the first motor driving portion 8 and the current of the second motor driving portion 10 (an expected value of the phase current) based on the torque control request instruction and the rotational position of the third rotational sensor 42.

Now, when a failure has occurred in, for example, the first control portion 9, the waveforms of the motor phase currents (U, V, and W) detected by the second phase-current monitor circuit 36 and the third phase-current monitor circuit 37 deviate from the expected value. The second control portion 11 determines that a failure has occurred in the first control portion 9 based on the fact that the waveform of the motor phase current detected by the second phase-current monitor circuit 36 deviates from the expected value. Further, the third control portion 41 determines that a failure has occurred in the first control portion 9 based on the fact that the waveform of the motor phase current detected by the third phase-current monitor circuit 37 deviates from the expected value.

When the waveform of the motor phase current in the first motor driving portion 8 deviates from the expected value, it is considered that, for example, the first electric power source 29 malfunctions, or the microcomputer or the pre-driver of the first control portion 9 operates improperly. The second phase-current monitor circuit 36 and the third phase-current monitor circuit 37 detect that the waveform of the motor phase current deviates from the expected value due to such a malfunction, an improper operation, or the like. When determining that a failure has occurred in the first control portion 9, the second control portion 11 outputs the abnormality instruction signal (1: High) for blocking the first fail-safe relay 8B to the first logical circuit 43. Further, when determining that a failure has occurred in the first control portion 9, the third control portion 41 outputs the abnormality instruction signal (1: High) for blocking the first fail-safe relay 8B to the first logical circuit 43.

At this time, the first fail-safe relay 8B is blocked according to the truth table of the first fail-safe relay 8B illustrated in FIG. 6 (A), and the electric power supply from the first motor driving portion 8 to the brake motor 2 is stopped. Along therewith, the second control portion 11 or the third control portion 41 notifies the integrated control apparatus 33 that a failure has occurred in the first control portion 9. Upon acquiring the notification from the second control portion 11 or the third control portion 41 (the notification indicating that a failure has occurred in the first control portion 9), the integrated control apparatus 33 transitions to a state waiting for degradation control as necessary. As the degradation control, the integrated control apparatus 33 can, for example, limit the vehicle speed, change the braking balance, or change a waiting position and a clearance of a target wheel.

Now, the first control portion 9 may output the abnormality instruction signal (1: High) for blocking the second fail-safe relay 10B to the second logical circuit 44 according to the occurrence of a failure in the first control portion 9 despite the fact that the control current of the second motor driving portion 10 is actually correct. However, in this case, the abnormality instruction signal (1: High) for blocking the second fail-safe relay 10B is not output from the third control portion 41 to the second logical circuit 44, and therefore the second fail-safe relay 10B is not blocked. In this manner, in the embodiment, the motor control apparatus 7 includes the logical circuits (the first logical circuit 43 and the second logical circuit 44) that function based on the consensus between two or more ECUs, and makes a determination by a majority vote. As a result, the motor control apparatus 7 can block the ECU side where a failure (an abnormality) has occurred and can also be prevented from erroneously blocking the ECU side in normal operation. The case when a failure has occurred in the second control portion 11 is similar to when a failure has occurred in the first control portion 9 except for such a difference that the first control portion 9 and the third control portion 41 block the second fail-safe relay 10B via the second logical circuit 44. Therefore, the description of the operation when a failure has occurred in the second control portion 11 will be omitted herein.

FIG. 5 illustrates control processing (current monitoring processing) performed by the first control portion 9, the second control portion 11, and the third control portion 41. The control processing illustrated in FIG. 5 is, for example, repeatedly performed per predetermined control cycle (for example, 1 ms). In the following description, the control processing will be described citing the processing performed by the first control portion 9 as a representative example. The processing performed by the second control portion 11 and the processing performed by the third control portion 41 are similar to the processing performed by the first control portion 9 except for differences in the target to be monitored and the relay to be blocked, and therefore the descriptions thereof will be omitted herein.

For example, upon a start of electric power supply to the first control portion 9, the processing illustrated in FIG. 5 is started. In S1, the first control portion 9 determines whether a failure (an abnormality) has occurred on the second control portion 11 side. More specifically, the first control portion 9 determines whether the waveform of the phase current in the second motor driving portion 10 falls out of the range of the expected current waveform via the first phase-current monitor circuit 35. In other words, the first control portion 9 determines whether the current control value of the second motor driving portion 10 by the second control portion 11 is different from the current control value of the first control portion 9 used as the expected value via the first phase-current monitor circuit 35.

If “NO” is determined in S1, i.e., the waveform of the phase current in the second motor driving portion 10 is determined to be within the range of the expected current waveform, the processing retums. In other words, the processing returns to START via RETURN, and is repeated from S1. If “NO” is determined in S1 and the processing returns, an abnormality counter supposed to be incremented in S2, which will be described below, is reset. On the other hand, if “YES” is determined in S1, i.e., the waveform of the phase current in the second motor driving portion 10 is determined to fall out of the range of the expected current waveform, the processing proceeds to S2.

In S2, the abnormality counter is incremented. In step S3 subsequent to S2, the first control portion 9 determines whether the count value of the abnormality counter is equal to or larger than a threshold value. The threshold value of the count value can be set to, for example, a time based on which the occurrence of an abnormality (a failure) can be reliably determined, i.e., a time that can prevent an abnormality (a failure) from being inadvertently determined despite the fact that the normal operation is actually maintained due to false temporary detection of the phase current, an error, or the like. If “NO” is determined in S3, i.e., the count value of the abnormality counter is determined not to be equal to or larger than the threshold value, the processing returns. In this case, the processing is repeated from S1 without resetting the abnormality counter.

On the other hand, if “YES” is determined in S3, i.e., the count value of the abnormality counter is determined to be equal to or larger than the threshold value, the processing proceeds to S4. In this case, the occurrence of an abnormality (a failure) can be determined. Therefore, in S4, the signal for blocking the relay is output. For example, in the case of the first control portion 9, the first control portion 9 outputs 1 (High) set as the abnormality instruction signal to the NAND circuit 44A of the second logical circuit 44. Along therewith, the first control portion 9 notifies the integrated control apparatus 33 that an abnormality (a failure) has occurred on the second control portion 11 side. In the case of the second control portion 11, the second control portion 11 outputs 1 (High) set as the abnormality instruction signal to the NAND circuit 43A of the first logical circuit 43. Along therewith, the second control portion 11 notifies the integrated control apparatus 33 that an abnormality (a failure) has occurred on the first control portion 9 side.

In the case of the third control portion 41, the third control portion 41 outputs the abnormality instruction signal to the NAND circuit 43A of the first logical circuit 43 if the phase current of the first control portion 9 side has a deviant waveform, and outputs the abnormality instruction signal to the NAND circuit 44A of the second logical circuit 44 if the phase current of the second control portion 11 side has a deviant waveform. Along therewith, the third control portion 41 notifies the integrated control apparatus 33 that an abnormality (a failure) has occurred on the first control portion 9 side or an abnormality (a failure) has occurred on the second control portion 11 side. After the abnormality instruction signal is output and the integrated control apparatus 33, which is the higher-level ECU, is notified that an abnormality (a failure) has occurred, the processing returns. At this time, the abnormality counter is not reset. When being notified that an abnormality (a failure) has occurred, the integrated control apparatus 33 determines whether the degradation control (for example, limiting the vehicle speed, changing the braking balance, or changing the waiting position and the clearance of the target wheel) is necessary. Then, if determining that the degradation control is necessary, the integrated control apparatus 33 performs the degradation control, such as limiting the vehicle speed, changing the braking balance, or changing the waiting position and the clearance of the target wheel.

In this manner, according to the embodiment, the motor control apparatus 7 includes the three control portions (ECUs), namely, the first control portion 9, the second control portion 11, and the third control portion 41. Along with that, the first control portion 9, the second control portion 11, and the third control portion 41 acquire the rotational position of the brake motor 2 from the first rotational sensor 15, the second rotational sensor 16, and the third rotational sensor 42, which are the rotational position detection portions separate from one another. In addition thereto, the first control portion 9, the second control portion 11, and the third control portion 41 mutually monitor the phase current of the first motor driving portion 8 and the phase current of the second motor driving portion 10. Therefore, for example, even when the first control portion 9 is unequipped with the self-diagnosis function. the second control portion 11 and the third control portion 41 can determine whether the “first control portion 9 or the first motor driving portion 8” is abnormal based on the rotational position of the brake motor 2 and the phase current.

Further, even when the second control portion 11 is unequipped with the self-diagnosis function, the first control portion 9 and the third control portion 41 can determine whether the “second control portion 11 or the second motor driving portion 10” is abnormal based on the rotational position of the brake motor 2 and the phase current. Due to that, the cost reduction can be achieved for the first control portion 9 and the second control portion 11. In addition, when an abnormality is determined, the control portion 9 (11) and the motor driving portion 8 (10) determined to be abnormal can be stopped, and the driving of the brake motor 2 can also be continued by the control portion 11 (9) and the motor driving portion 10 (8) determined not to be abnormal. Due to that, the redundancy can be secured. As a result, both the cost reduction and the redundancy can be achieved at the same time. In other words, the cost reduction can be achieved while the redundancy is established.

According to the embodiment, the first motor driving portion 8 includes the first fail-safe relay 8B, which switches the connection and the disconnection between the first inverter circuit 8A and the first electric power source 29. Under this condition, the second control portion 11 outputs the first abnormality instruction signal (1: High) for blocking the first fail-safe relay 8B based on the current phase determined based on the detection value of the second rotational sensor 16 and the phase current value of the first motor driving portion 8. In addition thereto, the third control portion 41 outputs the second abnormality instruction signal (1: High) for blocking the first fail-safe relay 8B based on the current phase determined based on the detection value of the third rotational sensor 42 and the phase current value of the first motor driving portion 8. Therefore, the first fail-safe relay 8B of the first motor driving portion 8 can switch the connection and the disconnection between the first inverter circuit 8A and the first electric power source 29 using the two signals, the first abnormality instruction signal and the second abnormality instruction signal.

According to the embodiment, when both the first abnormality instruction signal (1: High) and the second abnormality instruction signal (1: High) are output, the first fail-safe relay 8B is blocked. Therefore, when both the second control portion 11 and the third control portion 41 determine that the first control portion 9 side is abnormal, the driving of the brake motor 2 by the first motor driving portion 8 can be stopped. To put it the other way around, when one of the second control portion and the third control portion (only one of them) determines that the first control portion 9 side is abnormal, the driving of the brake motor 2 by the first motor driving portion 8 can be continued. Therefore, whether the first control portion 9 side is abnormal can be correctly determined, and the driving of the brake motor 2 by the first motor driving portion 8 can be reliably stopped when the first control portion 9 side is determined to be abnormal. The same also applies to the second fail-safe relay 10B.

In the embodiment, the active high logic is employed for the functions intended by the outputs of the first control portion 9, the second control portion 11, and the third control portion 41 (enable/disable). Further, regarding the result of the logical output, the safety design concept/policy is designed in such a manner that the enable signal (Enable signal) for the main function is represented by a recessive signal (recessive) and the disable signal (Disable signal) for the safety function is represented by a dominant signal (dominant).

According to the embodiment, when the first fail-safe relay 8B is blocked, the second control portion 11 or the third control portion 41 notifies the integrated control apparatus 33 of the abnormality in the first control portion 9 or the first motor driving portion 8. Therefore, the integrated control apparatus 33 can be aware that the first fail-safe relay 8B is blocked. Either both or one of the second control portion 11 and the third control portion 41 may notify the integrated control apparatus 33 of the abnormality. Further, when the second fail-safe relay 10B is blocked, the first control portion 9 or the third control portion 41 notifies the integrated control apparatus 33 of the abnormality in the second control portion II or the second motor driving portion 10. At this time, either both or one of the first control portion 9 and the third control portion 41 may notify the integrated control apparatus 33 of the abnormality. The integrated control apparatus 33 can perform necessary control such as the degradation control when being notified of the abnormality.

Whether the first fail-safe relay 8B and the first fail-safe relay 8B operate normally. i.e., can be appropriately blocked can be diagnosed, for example, when the first control portion 9, the second control portion 11, the third control portion 41, and the integrated control apparatus 33 are started up (initial diagnosis). For example, when the first control portion 9, the second control portion 11, the third control portion 41, and the integrated control apparatus 33 are started up, all of the eight conditions are executed for each of the relays according to the truth table illustrated in FIG. 6 as the initial diagnosis. At this time, whether the first fail-safe relay 8B and the first fail-safe relay 8B operate normally can be determined by monitoring the voltage value on the downstream side of the relay.

Further, whether the current control and the current detection are normal can be also diagnosed (initial diagnosis) with respect to the current control by the first control portion 9 and the first motor driving portion 8, the current control by the second control portion 11 and the second motor driving portion 10, the current detection of the first phase-current monitor circuit 35, the current detection of the second phase-current monitor circuit 36, the current detection of the third phase-current monitor circuit 37, and the current detection of the fourth phase-current monitor circuit 38. For example, when the first control portion 9, the second control portion 11, the third control portion 41, and the integrated control apparatus 33 are started up, a torque instruction in the forward direction is output from the first control portion 9 to the first motor driving portion and a torque instruction in the reverse direction is output from the second control portion 11 to the second motor driving portion so as to prohibit the brake motor 2 from rotating as the initial diagnosis. Whether the current control and the current detection are normal can be determined by monitoring the rotation of the brake motor 2 and the phase current at this time.

According to the embodiment, the first control portion 9 and the second control portion 11 are unequipped with the self-diagnosis function. Therefore, a low-cost microcomputer (ECU) can be employed as the first control portion 9 and the second control portion 11. On the other hand, a microcomputer (ECU) for monitoring a current can be employed as the third control portion 41. In other words, the third control portion 41 does not have to control the motor drive (the motor driving portion) (control the motor per short execution cycle and in a complicated manner) unlike the microcomputer (ECU) for motor control. Therefore, the cost reduction can also be achieved for the third control portion 41. However, the cost may vary depending on a condition such as a past record of the quantity actually employed for other products (a quantity term). Therefore, an arithmetic device for motor control may be employed as the third control portion 41. In either case, a low-functionality arithmetic device can be employed as the third control portion 41, and therefore the cost reduction can be expected.

According to the embodiment, the ASIL rating of the first control portion 9 and the ASIL rating of the second control portion 11 comply with ASIL-B. Therefore, a low-cost microcomputer (ECU) in compliance with ASIL-B can be employed as the first control portion 9 and the second control portion 11.

According to the embodiment, the first control portion 9, the second control portion 11, and the third control portion 41 are connected to the integrated control apparatus 33. Therefore, the first control portion 9, the second control portion 11, and the third control portion 41 can communicate (transmit and receive) necessary information (signal) between them and the integrated control apparatus 33.

According to the embodiment, the integrated control apparatus 33 is an integrated controller that determines the control of a motion of the vehicle, and is equipped with the self-diagnosis function. Therefore, the first control portion 9, the second control portion 11, and the third control portion 41 can be connected to the integrated controller equipped with the self-diagnosis function. On the other hand, both the first control portion 9 and the second control portion 11 are unequipped with the self-diagnosis function. Therefore, a low-cost microcomputer (ECU) can be employed as the first control portion 9 and the second control portion 11.

According to the embodiment, the first control portion 9, the second control portion 11, the third control portion 41, and the integrated control apparatus 33 establish a ring network. Therefore, even when, for example, the route (the communication line) connecting the first control portion 9 and the integrated control apparatus 33, the route (the communication line) connecting the second control portion 11 and the integrated control apparatus 33, the route (the communication line) connecting the third control portion 41 and the first control portion 9, or the route (the communication line) connecting the third control portion 41 and the second control portion 11 is disconnected (cut), necessary information (signal) can be communicated (transmitted and received) among the first control portion 9, the second control portion 11, the third control portion 41, and the integrated control apparatus 33.

More specifically, the first control portion 9, the second control portion 11, the third control portion 41, and the integrated control apparatus 33 can establish a ring network by communicating the information in the clockwise direction and the counterclockwise direction among them. Therefore, the information communicated in the clockwise direction and the counterclockwise direction can be unloaded onto and loaded from each device in the communication route (the first control portion 9, the second control portion 11, the third control portion 41, and the integrated control apparatus 33). Due to that, the information can be communicated to each device even with one of the routes disconnected. However, a delay in the communication of the information may vary to some degree. Therefore, to put it the other way around, it is considered that the timing can be also monitored by monitoring the delay in the communication of the information under normal conditions.

According to the embodiment, the motor driven by the first motor driving portion 8 and the second motor driving portion 10 is provided as the brake motor 2 that controls the electric brake mechanism. Therefore, the brake motor 2 can be driven by the first motor driving portion 8 connected to the first control portion 9 and the second motor driving portion 10 connected to the second control portion 11.

The embodiment has been described citing the example in which the current monitor circuits 35, 36, 37, and 38 are configured to detect the currents of the three phases, the U phase, the V phase, and the W phase as their current detection of them. However, the current detection is not limited thereto, and, for example, the currents of two phases among the three phases may be detected and the remaining one phase may be estimated. In other words, an introduced current necessarily flows out via a motor route in a motor star connection, and therefore the sum of the currents of the U phase, the V phase, and the W phase should be necessary zero, and the remaining one phase can be estimated as long as the currents of two phases can be detected. Therefore, the currents of two phases among the three phases may be detected and the remaining one phase may be estimated. Further, one possible method for monitoring the phase current is to use a shunt resistance, and the shunt resistance may be either non-redundantly provided (one) or redundantly provided (two).

The embodiment has been described citing the example in which the first control portion 9 and the second control portion 11 are configured to be unequipped with the self-diagnosis function. However, the first control portion 9 and the second control portion 11 are not limited thereto, and, for example, one or both of them may be configured to be equipped with a low-precision (low-functionality) self-diagnosis function. Alternatively, for example, one or both of the first control portion 9 and the second control portion 11 may be configured to be equipped with a high-precision (high-functionality) self-diagnosis function. In this case, the ASIL rating of the first control portion 9 and/or the ASIL rating of the second control portion do(es) not have to comply with ASIL-B. In other words, the ASIL rating of the first control portion 9 and/or the ASIL rating of the second control portion may comply with ASIL-A, ASIL-C, or ASIL-D.

The embodiment has been described citing the example in which the motor control apparatus 7 has a dual system configuration including the first control portion 9 (the secondary system) and the second control portion 11 (the primary system). However, without being limited thereto, the present invention can be used for, for example, a multisystem configuration including dual or more systems, such as triple systems or quad systems.

The embodiment has been described citing the example in which the motor driven by the first motor driving portion 8 and the second motor driving portion 10 is provided as the brake motor 2 that controls the electric brake mechanism configured to provide the braking force to the vehicle. However, the motor driven by the first motor driving portion and the second motor driving portion is not limited thereto, and, may be provided as, for example, a steering motor that controls (drives) a steering actuator of a vehicle. In this case, the steering motor can be driven by the first motor driving portion connected to the first control portion and the second motor driving portion connected to the second control portion. In either case, the motor driven by the first motor driving portion and the second motor driving portion is not limited to the brake motor and the steering motor, and can be provided as a motor for driving various kinds of actuators mounted on a vehicle (a motor for which redundancy should be secured). In this case, for example, the motor can be such a motor that, when the function of one of systems has failed, the remaining one of the systems should continue the control, such as a water pump, an oil pump, or a running motor required to be redundantly configured. In other words, the motor control apparatus and the motor control system according to the embodiment can be widely applied as a control apparatus and a control system of such a motor that, when the function of one of systems has failed, the remaining one of the systems can continue the control of the motor (One Fail-Operational).

The embodiment has been described citing the example in which the controller of the vehicle (the vehicle controller) is provided as the integrated control apparatus 33 (the integrated ECU or the central ECU), which determines the vehicle motion control for moving the vehicle according to the target trajectory acquired from the autonomous driving control apparatus (the autonomous driving ECU). However, without being limited thereto, the controller of the vehicle (the vehicle controller) may be a control apparatus different from the integrated control apparatus 33, such as the steering control apparatus or the suspension control apparatus, i.e., does not have to be a higher-level control apparatus. Various kinds of control apparatuses (ECUs) mounted on the vehicle can be used as the controller of the vehicle (the vehicle controller).

According to the above-described embodiment, the motor control apparatus (the motor controller) includes the three control portions, the first control portion, the second control portion, and the third control portion. Along with that, the first control portion, the second control portion, and the third control portion acquire the rotational position of the motor from the separate rotational position detection portions (the first rotational position detection portion, the second rotational position detection portion, and the third rotational position detection portion), respectively. In addition thereto, the first control portion, the second control portion, and the third control portion mutually monitor the phase current of the first motor driving portion and the phase current of the second motor driving portion. Therefore, for example, even when the first control portion is unequipped with the self-diagnosis function, the second control portion and the third control portion can determine whether the “first control portion or the first motor driving portion” is abnormal based on the rotational position of the motor and the phase current. Further, even when the second control portion is unequipped with the self-diagnosis function, the first control portion and the third control portion can determine whether the “second control portion or the second motor driving portion” is abnormal based on the rotational position of the motor and the phase current. As a result, the cost reduction can be achieved for the first control portion and the second control portion.

In addition, when an abnormality is determined, the control portion and the motor driving potion determined to be abnormal can be stopped and the driving of the motor can also be continued by the control portion and the motor driving portion not determined to be abnormal. Due to that, the redundancy can be secured. As a result, both the cost reduction and the redundancy can be achieved at the same time. In other words, the cost reduction can be achieved while the redundancy is established.

According to the embodiment, the first motor driving portion includes the first relay portion, which switches the connection and the disconnection between the first bridge circuit portion and the electric power source. Under this condition, the second control portion outputs the first abnormality instruction signal for blocking the first relay portion based on the current phase determined based on the detection value of the second rotational position detection portion and the phase current value of the first motor driving portion. In addition thereto, the third control portion outputs the second abnormality instruction signal for blocking the first relay portion based on the current phase determined based on the detection value of the third rotational position detection portion and the phase current value of the first motor driving portion. Therefore, the first relay portion of the first motor driving portion can switch the connection and the disconnection between the first bridge circuit portion and the electric power source using the two signals, the first abnormality instruction signal and the second abnormality instruction signal.

According to the embodiment, when both the first abnormality instruction signal and the second abnormality instruction signal are output, the first relay portion is blocked.

Therefore, when both the second control portion and the third control portion determine that the “first control portion or the first motor driving portion” is abnormal, the driving of the motor by the first motor driving portion can be stopped. To put it the other way around, when one of the second control portion and the third control portion (only one of them) determines that the “first control portion or the first motor driving portion” is abnormal, the driving of the motor by the first motor driving portion can be continued. Therefore, whether the “first control portion or the first motor driving portion” is abnormal can be correctly determined, and the driving of the motor by the first motor driving portion can also be reliably stopped when the first control portion or the first motor driving portion is determined to be abnormal.

According to the embodiment, when the first relay portion is blocked, the second control portion or the third control portion notifies the controller of the vehicle of the abnormality in the first control portion or the first motor driving portion. Therefore, the controller of the vehicle can be aware that the first relay portion is blocked.

According to the embodiment, the first control portion and the second control portion are unequipped with the self-diagnosis function. Therefore, a low-cost microcomputer (ECU) can be employed as the first control portion and the second control portion.

According to the embodiment, the ASIL rating of the first control portion and the ASIL rating of the second control portion comply with ASIL-B. Therefore, a low-cost microcomputer (ECU) in compliance with ASIL-B can be employed as the first control portion and the second control portion.

According to the embodiment, the first control portion, the second control portion, and the third control portion are connected to the controller of the vehicle. Therefore, the first control portion, the second control portion, and the third control portion can communicate (transmit and receive) necessary information (signal) between them and the controller of the vehicle.

According to the embodiment, the controller of the vehicle is an integrated controller that determines the control of a motion of the vehicle, and is equipped with the self-diagnosis function. Therefore, the first control portion, the second control portion, and the third control portion can be connected to the integrated controller equipped with the self-diagnosis function. On the other hand, both the first control portion and the second control portion are unequipped with the self-diagnosis function. Therefore, a low-cost microcomputer (ECU) can be employed as the first control portion and the second control portion.

According to the embodiment, the first control portion, the second control portion. the third control portion, and the controller of the vehicle establish a ring network. Therefore, even when, for example, the route (the communication line) connecting the first control portion and the controller of the vehicle, the route (the communication line) connecting the second control portion and the controller of the vehicle, the route (the communication line) connecting the third control portion and the first control portion, or the route (the communication line) connecting the third control portion and the second control portion is disconnected (cut), necessary information (signal) can be communicated (transmitted and received) among the first control portion, the second control portion, the third control portion, and the controller of the vehicle.

According to the embodiment, the motor is the brake motor that controls the electric brake mechanism. Therefore, the brake motor can be driven by the first motor driving portion connected to the first control portion and the second motor driving portion connected to the second control portion.

The present invention shall not be limited to the above-described embodiment, and includes various modifications. For example, the above-described embodiment has been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment.

Further, each embodiment can also be implemented with another configuration added, deleted, or replaced with respect to a part of the configuration of this embodiment.

The present application claims priority under the Paris Convention to Japanese Patent Application No. 2022-117009 filed on Jul. 22, 2022. The entire disclosure of Japanese Patent Application No. 2022-117009 filed on Jul. 22, 2022 including the specification, the claims, the drawings, and the abstract is incorporated herein by reference in its entirety.

### REFERENCE SIGNS LIST

1 motor control system
2 brake motor (motor)
7 motor control apparatus (motor controller)
8 first motor driving portion
8A first inverter circuit (first bridge circuit portion)
8B first fail-safe relay (first relay portion)
9 first control portion
10 second motor driving portion
11 second control portion
15 first rotational sensor (first rotational position detection portion)
16 second rotational sensor (second rotational position detection portion)
29 first electric power source (electric power source)
33 integrated control apparatus (controller of vehicle, vehicle controller, integrated controller)
41 third control portion
42 third rotational sensor (third rotational position detection portion)

1. A motor control apparatus comprising:
a first motor driving portion configured to drive a motor;
a second motor driving portion configured to drive the motor;
a first control portion connected to the first motor driving portion, the first control portion being configured to acquire a detection value of a first rotational position detection portion, which detects a rotational position of the motor, and monitor a phase current of the second motor driving portion;
a second control portion connected to the second motor driving portion, the second control portion being configured to acquire a detection value of a second rotational position detection portion, which detects the rotational position of the motor, and monitor a phase current of the first motor driving portion; and
a third control portion configured to acquire a detection value of a third rotational position detection portion, which detects the rotational position of the motor, and monitor the phase current of the first motor driving portion and the phase current of the second motor driving portion.

2. The motor control apparatus according to claim 1, wherein the first motor driving portion includes
a first bridge circuit portion, and
a first relay portion configured to switch a connection and a disconnection between the first bridge circuit portion and an electric power source,
wherein the second control portion outputs a first abnormality instruction signal for blocking the first relay portion based on a current phase determined based on the detection value of the second rotational position detection portion, and a phase current value of the first motor driving portion, and
wherein the third control portion outputs a second abnormality instruction signal for blocking the first relay portion based on a current phase determined based on the detection value of the third rotational position detection portion, and a phase current value of the first motor driving portion.

3. The motor control apparatus according to claim 2, wherein, when both the first abnormality instruction signal and the second abnormality instruction signal are output. the first relay portion is blocked.

4. The motor control apparatus according to claim 3, wherein the first control portion, the second control portion, and the third control portion are connected to a controller of a vehicle, and
wherein, when the first relay portion is blocked, the second control portion or the third control portion notifies the controller of the vehicle of an abnormality in the first control portion or the first motor driving portion.

5. The motor control apparatus according to claim 1, wherein the first control portion and the second control portion are unequipped with a self-diagnosis function.

6. The motor control apparatus according to claim 1, wherein an ASIL rating of the first control portion and an ASIL rating of the second control portion comply with ASIL-B.

7. The motor control apparatus according to claim 1, wherein the first control portion, the second control portion, and the third control portion are connected to a controller of a vehicle.

8. The motor control apparatus according to claim 7, wherein the controller of the vehicle is an integrated controller that determines control of a motion of the vehicle, and is equipped with a self-diagnosis function, and wherein both the first control portion and the second control portion are unequipped with the self-diagnosis function.

9. The motor control apparatus according to claim 7, wherein the first control portion, the second control portion, the third control portion, and the controller of the vehicle establish a ring network.

10. The motor control apparatus according to claim 1, wherein the motor is a brake motor configured to control an electric brake mechanism that provides a braking force to a vehicle.

11. A motor control system comprising:
a motor; and
a motor controller configured to control the motor,
the motor controller including
a first motor driving portion configured to drive the motor,
a second motor driving portion configured to drive the motor,
a first control portion connected to the first motor driving portion, the first control portion being configured to acquire a detection value of a first rotational position detection portion, which detects a rotational position of the motor, and monitor a phase current of the second motor driving portion,
a second control portion connected to the second motor driving portion, the second control portion being configured to acquire a detection value of a second rotational position detection portion, which detects the rotational position of the motor, and monitor a phase current of the first motor driving portion, and
a third control portion configured to acquire a detection value of a third rotational position detection portion, which detects the rotational position of the motor, and monitor the phase current of the first motor driving portion and the phase current of the second motor driving portion.
the motor control system further comprising;
a vehicle controller connected to the first control portion, the second control portion. and the third control portion.
